(19) United States
(12) Patent Application Publication
(10) Pub. No.: US 2017/0289883 A1
(43) Pub. Date: Oct. 5, 2017

(54) EMERGENCY SERVICES HANDOVER BETWEEN UNTRUSTED WLAN ACCESS AND CELLULAR ACCESS

(71) Applicant: Apple Inc., Cupertino, CA (US)

(72) Inventors: Krisztian KISS, Hayward, CA (US); Rafael L. RIVERA-BARRETO, Santa Clara, CA (US); Rohan C. MALTHANKAR, San Jose, CA (US); Vikram Bhaskara YERRABOMMANAHALLI, Sunnyvale, CA (US); Xuqiang HUA, San Jose, CA (US)

(21) Appl. No.: 15/476,354

(22) Filed: Mar. 31, 2017

Related U.S. Application Data
(60) Provisional application No. 62/317,365, filed on Apr. 1, 2016.

(51) Int. Cl. H04W 36/14; H04W 8/26; H04W 12/04; H04L 29/06; H04W 12/06; H04W 4/22; H04W 76/02

(52) U.S. Cl. CPC H04W 36/14; H04W 4/22; H04W 8/26; H04W 76/022; H04L 63/0428; H04W 12/06; H04W 12/04

(57) ABSTRACT

Apparatus and methods to support handover of emergency services sessions by network elements and by a wireless device between wireless networks are disclosed. The wireless device indicates an emergency services handover to applicable network elements, including an evolved Packet Data Gateway (ePDG), in one more messages when transferring an established emergency services session from a cellular wireless network to an untrusted non-cellular wireless network. In some embodiments, the wireless device includes a predefined string as part of a set of identification data in an IKE_AUTH request message sent to the ePDG. In some embodiments, the wireless device includes a previously allocated IP address within a payload of the IKE_AUTH request message to indicate handover of an existing session. By providing both the predefined “EMERGENCY” string and the previously allocated IP address, the wireless indicates a handover of an emergency services session between wireless networks.

### CROSS-REFERENCE TO RELATED APPLICATIONS

This Application claims the benefit of U.S. Provisional Patent Application No. 62/317,365, entitled “EMERGENCY SERVICES HANDOVER BETWEEN UNTRUSTED WLAN ACCESS AND CELLULAR ACCESS” and filed Apr. 1, 2016, the content of which is incorporated herein by reference in its entirety for all purposes.

### FIELD

The described embodiments generally relate to wireless communications, including methods and apparatus to support handover of established emergency services sessions between untrusted non-cellular wireless networks and cellular wireless networks by a wireless communication device.

### BACKGROUND

Fourth generation (4G) cellular wireless networks, which use newer radio access technologies that implement one or more 3^{rd} Generation Partnership Project (3GPP) Long Term Evolution (LTE) and LTE Advanced (LTE-A) standards, are rapidly being developed and deployed by network operators worldwide. The newer cellular wireless networks provide a range of packet based services in parallel with legacy second generation (2G) and third generation (3G) wireless networks that can provide both circuit-switched voice services and packet-switched data services. The cellular wireless networks overlap with multiple wireless local area network (WLAN) based networks, which provide additional localized high-speed access for various services. Wireless communication devices can include capabilities to connect with different wireless networks individually or in parallel based on various criteria, e.g., based on what wireless networks are available at a particular location, based on various capabilities of available wireless networks, based on capabilities of the wireless communication device, based on properties of particular services provided by one or more of the wireless networks, and/or based on service subscriptions with which the wireless communication device and/or the user thereof is associated. Wireless communication devices can include wireless radio circuitry that provides for communication via multiple radio frequency interfaces that can connect through different wireless networks individually and/or in parallel. Wireless cellular network service providers are adding WLAN connectivity to provide access to cellular services through WLAN networks for cellular service subscribers to supplement access via cellular wireless access networks. Access to emergency services, such as “911” and “e911”, can be provided for wireless communication devices when normal access to services would be otherwise denied, such as when a wireless communication device can be unable to authenticate to establish a session. In addition, wireless continuity capabilities to seamlessly transfer established communication sessions between WLAN-based networks and cellular networks are also being developed and deployed. Normally, handover of an established communication session includes authentication and authorization when transferring between different wireless networks; however, an emergency services session can be established without full authentication and authorization completion. As such, there exists a need for solutions that provide for managing handover of established emergency services sessions, including in the absence of authentication, by wireless communication devices when switching access networks, particularly of different wireless network types, such as between a non-cellular wireless access network, e.g., a WLAN-based network, and a cellular wireless access network.

### SUMMARY

Apparatus and methods to support handover of emergency services sessions by network elements and by a wireless communication device, such as a user equipment (UE), between cellular wireless networks and non-cellular wireless networks are disclosed. Representative embodiments include methods and apparatuses to indicate an emergency services handover to applicable network elements when transferring an established emergency services session for the UE between wireless networks. The UE provides an indication of the emergency services handover in one or more messages sent to an evolved Packet Data Gateway (ePDG) when seeking to transfer an existing emergency services session from a cellular wireless network to an untrusted non-cellular wireless network. In some embodiments, the UE includes a predefined string, e.g., “EMERGENCY”, as part of a set of identification data in an IKE_AUTH request message sent to the ePDG. In some embodiments, the UE includes a previously allocated IP address provided during establishment of an IPSec tunnel within a payload of the IKE_AUTH request message to indicate handover of an existing session. By providing both the predefined “EMERGENCY” string and the previously allocated IP address, the UE indicates a handover of an emergency services session between wireless networks. The UE also provides an identity of the UE to the ePDG when handing over the established emergency services session using either an International Mobile Equipment Identity (IMEI), for an unauthenticated UE with no USIM, or an International Mobile Subscriber Identity (IMSI), for an unauthenticated UE with a USIM, as a user name for a Network Access Identifier (NAI). The NAI also includes a domain name that is specifically reserved for unauthenticated emergency services access to indicate no authentication will be completed for the establishment or handover of the emergency services session. Solutions provided herein may be used as part of and/or in conjunction with one or more 3GPP wireless communication protocols.

This Summary is provided merely for purposes of summarizing some example embodiments so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

Other aspects and advantages of the invention will become apparent from the following detailed description taken in conjunction with the accompanying drawings which illustrate, by way of example, the principles of the described embodiments.

### BRIEF DESCRIPTION OF THE DRAWINGS

The described embodiments and the advantages thereof may best be understood with reference to the following description taken in conjunction with the accompanying drawings. These drawings are not necessarily drawn to scale, and they are in no way intended to limit or exclude foreseeable modifications thereto in form and detail that may be made by one having ordinary skill in the art at the time of this disclosure.

FIG. 1 illustrates an exemplary wireless communication device configurable to connect individually or in parallel through a cellular wireless access network and a non-cellular wireless access network, in accordance with some embodiments.

FIG. 2 illustrates example network elements of wireless access networks and a core network, in accordance with some embodiments.

FIG. 3 illustrates a sequence diagram for an example message exchange to establish a secure tunnel between a wireless communication device and a network element, in accordance with some embodiments.

FIG. 4 illustrates a sequence diagram for a portion of an exemplary encryption and authentication message exchange when attempting to establish a connection including for handover of an established connection between wireless access networks, in accordance with some embodiments.

FIG. 5 illustrates a block diagram of a representative apparatus that can be implemented on a wireless communication device to support emergency services handover, in accordance with some embodiments.

FIG. 6 illustrates an example method to handover an emergency services session for a wireless communication device, in accordance with some embodiments.

FIG. 7 illustrates in block diagram format an example representative set of elements of a wireless communication device that can be used to implement the various components and techniques described herein, in accordance with some embodiments.

### DETAILED DESCRIPTION

Representative examples for supporting establishment or handover of established emergency services sessions between untrusted non-cellular wireless networks and cellular wireless networks are provided herein. These examples are provided to add context to, and to aid in the understanding of, the subject matter of this disclosure. It should be apparent that the present disclosure may be practiced with or without some of the specific details described herein. Further, various modifications and/or alterations can be made to the subject matter described herein, and illustrated in the corresponding figures, to achieve similar advantages and results, without departing from the spirit and scope of the disclosure.

### Overview

Apparatus and methods to support handover of emergency services sessions, by network elements and by a wireless communication device, such as by a user equipment (UE), between cellular wireless networks and untrusted non-cellular wireless networks are disclosed. Representative embodiments include methods and apparatuses to indicate an emergency services handover to applicable network elements when transferring an established emergency services session for the UE between different wireless networks, including to and/or from an untrusted non-cellular wireless network. An indication of an emergency services handover can be sent by the UE, both when the UE is authenticated (or capable of being authenticated) with the originating wireless network or with the receiving wireless network, and when the UE is unauthenticated (or incapable of being authenticated) with either wireless network. Emergency services sessions can be established and handed over when the UE is unable to authenticate, such as when the UE has no installed Universal Subscriber Identity Module (USIM), including no available physical SIM or no available electronic SIM (eSIM) for an embedded Universal Integrated Circuit Card (eUICC), or when the UE is operating in a location in which no available SIM or eSIM can be used, such as when restricted from regular services due to the UE's geographic location or when the UE is operating in a visited network without an existing roaming agreement between the UE's Home Public Land Mobile Network (HPLMN) and the visited PLMN (VPLMN).

When seeking to transfer an established emergency services session from a cellular wireless network, e.g., a 3GPP cellular wireless access network, to a non-cellular wireless network, e.g., an untrusted wireless local area network (WLAN) access network, the UE can provide an indication of the emergency services session handover in one or more messages sent to an evolved Packet Data Gateway (ePDG). In some embodiments, the UE includes a predefined string, e.g., the string “EMERGENCY”, as part of a set of Identification Data in a payload, e.g., in an “IDr” payload, of an IKE_AUTH request message sent to the ePDG. The IKE_AUTH request message can be sent as part of an IKEv2 Authentication and Tunnel Setup procedure between the UE and the ePDG, in conjunction with an Authentication and Authorization procedure between the ePDG and one or more Authentication, Authorization, and Accounting (AAA) servers. The predefined string included in the IKE_AUTH request message can be used to indicate the establishment of (when first setting up the emergency services session) and/or to indicate the handover of the emergency services session to another wireless network. The IKE_AUTH request message can be sent after receipt of an IKE_SA_INIT response received from the ePDG as part of an encryption setup procedure. In some embodiments, the UE includes in the IKE_AUTH request message a previously allocated IP address provided during establishment of an IPSec tunnel. The IP address can be included within a payload of the IKE_AUTH request message, e.g., in a CFG_REQUEST configuration payload, to indicate handover of an existing session (including handover of the emergency services session). The allocated IP address included in the IKE_AUTH request message can include an IPv4 address or an IPv6 address or both types of addresses. By providing both the predefined “EMERGENCY” string and the previously allocated IP address (or addresses) in the IKE_AUTH request message, the UE can indicate to the ePDG, a request to handover an established emergency services session between wireless networks.

When seeking to transfer an existing emergency services session from a non-cellular wireless network, e.g., from an untrusted WLAN wireless access network, to a cellular wireless network, e.g., a 3GPP cellular wireless access network, the UE can provide an indication of the emergency services handover in one or more messages to a Mobility Management Entity (MME). In some embodiments, the UE includes a predefined value, e.g., “Emergency Handover” in a Request Type information element (IE) of an ATTACH REQUEST message or of a packet data network (PDN) CONNECTIVITY REQUEST message. Inclusion of the Request Type IE in the ATTACH REQUEST message and/or in the PDN CONNECTIVITY REQUEST message can indicate that the UE seeks to establish a new connection to a PDN, or to keep a set of already established connections to the PDN, when handing over a session from the untrusted non-cellular wireless access network to the 3GPP cellular wireless access network. The UE can include the value “Handover” in the Request Type IE, when connectivity to the PDN is established upon handover from the untrusted WLAN wireless access network, and the UE was previously connected to the same PDN before the handover to the 3GPP cellular wireless access network. The Request Type IE can also indicate a type of session that is requested, such as for an emergency services session, based on a particular value in the Request Type IE, when establishing the session to the 3GPP cellular wireless access network or when transferring an established session from the untrusted WLAN wireless access network to the 3GPP cellular wireless access network. The Request Type IE can include a value “Emergency” when the UE requests a new PDN connection for an emergency services session. When handing over an emergency services session, the Request Type IE of an ATTACH REQUEST message or a PDN CONNECTIVITY REQUEST message can include a value of “Emergency Handover” to indicate a handover of an established PDN connection that transports emergency services bearer traffic, where the handover is between the untrusted WLAN wireless access network to the 3GPP cellular wireless access network.

When requesting a handover of an established emergency services session between a cellular wireless network and an untrusted non-cellular wireless network, in some embodiments, the UE provides an identity of the UE to the ePDG, e.g., in the IKE_AUTH request message sent to the ePDG. The identity provided for an emergency services session handover varies based on whether the UE includes an installed USIM (or an installed eSIM of an eUICC) that is valid for the cellular wireless network on which the established emergency services session exists before the handover. When the UE does not include a valid USIM, e.g., no USIM installed, (or does not include a valid eSIM on an eUICC), the UE provides the International Mobile Equipment Identity (IMEI) as an identity of the UE as part of a Network Access Identifier (NAI) included in the IKE_AUTH request message sent to the ePDG. The IMEI is used as the username in the NAI, which syntactically has the form “username@realm”. The NAI also includes, as the realm, a domain name that is reserved for unauthenticated emergency services access. As the NAI indicates a reserved domain name associated with unauthenticated emergency services access, the AAA server knows that the UE will be unable (at least in some circumstances) to complete authentication, and for the emergency services session handover, no authentication need be performed. When the UE includes an installed USIM (or an installed eSIM of an eUICC) and the UE is aware that authentication will fail for an associated wireless network, such as when a local Visited Public Land Mobile Network (VPLMN) does not have a roaming agreement with the Home PLMN (HPLMN) of the UE, the UE provides the International Mobile Subscriber Identity (IMSI) as the username of the NAI included in the IKE_AUTH request message sent to the ePDG. The UE includes the reserved domain name for unauthenticated emergency services access as part of the NAI to indicate that no authentication will be completed for the handover of the emergency services session from the cellular wireless network, e.g., the 3GPP cellular wireless access network, to the non-cellular wireless network, e.g., the untrusted WLAN wireless access network. The AAA server can indicate in response to the ePDG that the emergency services handover request is accepted without requiring authentication, and no subscription data for the UE is provided to the ePDG. The UE and the AAA server each can generate one or more encryption keys, such as a master session key (MSK), locally based at least in part on the provided identity of the UE (e.g., the IMEI or the IMSI), and the AAA server provides the generated one or more encryption keys to the ePDG to use for encryption of communication via an IPSec tunnel established between the UE and the ePDG for the emergency services session after the handover.

### Untrusted WLAN Access

Wireless service providers are deploying WLANs in parallel with cellular wireless networks to expand options for access to evolved packet core (EPC) services, such as Internet Protocol Multimedia Subsystem (IMS) based services including voice over IP (VOIP), and “Application” type services including visual voice mail (VVM), short message service (SMS), and multimedia message service (MMS). Access to these EPC services through a trusted WLAN can be realized using an S2a reference point interface, and access through an untrusted WLAN network can be realized using an S2b reference point interface. Wireless communication devices can support packet data network (PDN) connections through multiple wireless interfaces, such as via a cellular wireless interface and via a trusted or untrusted WLAN interface, both individually and in parallel. Wireless service providers can control access to services depending upon various criteria including, but not limited to, a location of the wireless communication device, whether the wireless communication device is on a “home” network or on a “roaming” network, based on the type of connection through which the wireless communication device connects including security establishment, a radio access technology (RAT) type for the access connection, a wireless communication device and/or user's subscription profile, etc. In order to ensure secure communication, connections by a wireless communication device that traverse an S2b reference point can use an Internet Key Exchange Version 2 (IKEv2) protocol between the wireless communication device and an evolved packet data gateway (ePDG).

To establish a connection, the wireless communication device uses authentication procedures based on EAP-AKA to access via an untrusted WLAN or based on EAP-AKA′ to access via a trusted WLAN without requiring input for a user of the wireless communication device. An authentication failure can occur, for different reasons, such as when the wireless communication device accesses via a WLAN that is deployed by a visited PLMN (VPLMN) into which the wireless communication device does not have permission to roam, or when the wireless communication device and/or a user thereof is not authorized to access the services of the EPC for the cellular service provider. Access to emergency services, however, can be required irrespective of a location at which the wireless communication device operates or a subscription service for a user of the wireless communication device. In fact, a wireless communication device without an installed SIM (physical or electronic) can be configured to allow access to emergency services, and wireless service providers can allow establishment of emergency services sessions for the wireless communication device without completion of a regular authentication and authorization procedure. A wireless service provider can allow for access to emergency services via a cellular wireless access network or via a non-cellular wireless access network. For wireless communication devices that support handover of an established session between different types of wireless networks, such as between a cellular wireless access network and a non-cellular wireless access network, it can be desirable to allow for handover of an established emergency services session without authentication and authorization completion by the wireless access network receiving the handover. As described herein, specific content for various messages can indicate that handover for an established session pertains to an emergency services session, and as such only partial or incomplete information normally used for authentication when establishing the session and/or when transferring the session may be available. Network elements used to establish secure connections and to permit establishment and/or transfer of sessions, such as AAA servers, PDN gateways, and ePDGs can recognize the emergency services session establishment and/or transfer and allow for a secure connection without full authentication completion.

References are made in this section to the accompanying drawings, which form a part of the disclosure and in which are shown, by way of illustration, various implementations corresponding to the described embodiments herein. Although the embodiments of this disclosure are described in sufficient detail to enable one having ordinary skill in the art to practice the described implementations, it should be understood that these examples are not to be construed as being overly-limiting or all-inclusive.

In accordance with various embodiments described herein, the terms “wireless communication device,” “wireless device,” “mobile device,” “mobile station,” and “user equipment” (UE) may be used interchangeably herein to describe one, or any number of, common consumer electronic device(s) that may be capable of performing procedures associated various embodiments the disclosure. In accordance with various implementations, any one of these consumer electronic devices may relate to: a cellular phone or a smart phone, a tablet computer, a laptop computer or a netbook computer, a media player device, an electronic book device, a MiFi® device, a wearable computing device, as well as any other type of electronic computing device having fourth generation (4G) LTE and LTE Advanced (LTE-A) or similar “later generation” cellular wireless access communication capabilities as well as wireless local area network communication capabilities. In various embodiments, these capabilities may allow a respective UE to communicate and manage simultaneous IP flows via multiple wireless access networks.

Additionally, it should be understood that the UEs described herein may be configured as multi-mode wireless communication devices that are also capable of communicating via legacy third generation (3G) and/or second generation (2G) RATs in addition to communicating with 4G wireless networks, as well as communicating using one or more different wireless local area networks. Multi-mode UEs can include support for communication in accordance with one or more different wireless communication protocols developed by standards bodies, e.g., 3GPP's Global System for Mobile Communications (GSM), Universal Mobile Telecommunications System (UMTS), LTE, and LTE-A standards or 3GPP2's CDMA2000 (1×RTT, 2×EV-DO, HRPD, eHRPD) standards. Multi-mode UEs can also support communication using wireless local area networking protocols, e.g., IEEE 802.11 (Wi-Fi), IEEE 802.16 (WiMAX), and wireless personal area networking protocols, e.g., Bluetooth®. Multiple wireless communication protocols can provide complementary functions and/or different services for a multi-mode UE.

IKEv2 is an Internet Engineering Task Force (IETF) specified protocol described in the Request For Comments (RFC) 5996 and RFC 7296 documents, which are incorporated by reference herein in their entirety for all purposes. The IKEv2 signaling protocol can be used to establish a security association between the UE and a network element, e.g., an evolved packet data gateway (ePDG), such as when establishing an Internet Protocol Security (IPsec) Encapsulated Security Protocol (ESP) tunnel between the UE and the network element to provide for secure communication between the UE and the network, such as based on mutual authentication and cryptographic key negotiation. The IKEv2 signaling protocol can also be used to exchange additional information between the UE and the ePDG using an extensibility mechanism, e.g., using information messages and information exchange sequences as defined, at least in part, in Sections 1.4 and 1.5 of RFC 5996. Additionally IETF RFC 4282 specifies the syntax for the Network Access Identifier (NAI), which provides a user identity for a client, e.g., the UE, during network authentication, while the 3GPP Technical Specification (TS) 23.402 Release 13 specifies architecture enhancements for non-3GPP accesses by wireless communication devices, e.g., the UE. Both IETF RFC 4282 and 3GPP TS 23.402 are incorporated by reference herein in their entirety for all purposes.

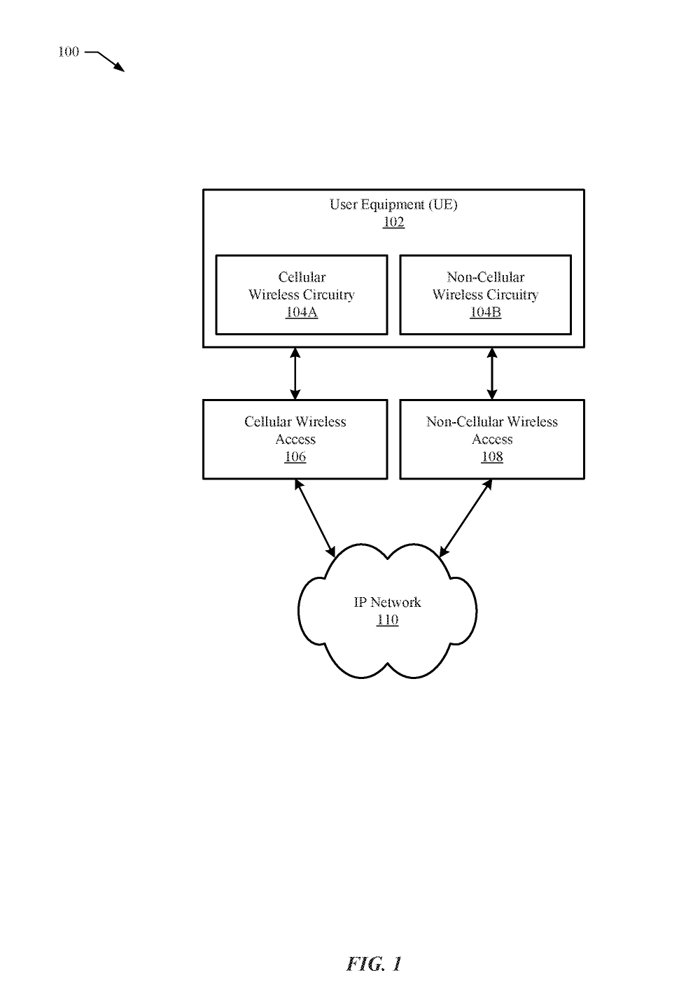

FIG. 1 illustrates an example wireless system 100 that includes an example wireless communication device, e.g., a user equipment (UE) 102, which includes wireless circuitry that can be configured to connect the UE 102 with one or more wireless networks individually or in parallel. The UE 102 includes both cellular wireless circuitry 104A, which can be configured to connect the UE 102 through a cellular wireless access 106 (which can also be referred to as a cellular wireless access network) to various services provided via an Internet Protocol (IP) packet based network 110, and non-cellular wireless circuitry 104B, which can be configured to connect the UE 102 through a non-cellular wireless access 108 (which can also be referred to as a non-cellular wireless access network) to the same IP network 110. An LTE evolved packet system (EPS) provides services to the UE 102, both “real-time” services, such as voice/video conference calls, and data communication services, such as web browsing and email access, using an IP protocol. The LTE EPS, as introduced in the Release 8 3GPP wireless communication standard, defines an architecture in which heterogeneous wireless access systems, such as a combination of cellular wireless access 106 and non-cellular wireless access 108, can be used by the UE 102 to connect to a common core network (not shown). The UE 102 can establish a packet data network (PDN) connection through one wireless access and subsequently add or change to a second wireless access. The UE 102 can communicate over multiple wireless accesses, such as the cellular wireless access 106 and the non-cellular wireless access 108, individually or simultaneously using the same PDN connection. In some circumstances, a wireless service provider can allow access to emergency services through either type of wireless access, e.g., the cellular wireless access 106, and through another type of wireless access, e.g., the non-cellular wireless access 108 without requiring completion of authentication by the UE 102. Thus, the UE 102 can access emergency services through an untrusted WLAN via an S2b interface IPSec tunnel or via a cellular wireless access network and seek to handover (transfer seamlessly) an established emergency services session between two different accesses, e.g., between a cellular wireless access network and an untrusted non-cellular wireless access network.

The cellular wireless circuitry 104A and the non-cellular wireless circuitry 104B provide for wireless radio frequency (RF) connections between the UE 102 and parallel wireless networks, which interconnect with the IP network 110 via the cellular wireless access 106 and the non-cellular wireless access 108 respectively. In some embodiments, the wireless circuitry 104A/B includes one or more baseband processor(s), and a set of RF analog front-end circuitry. In some embodiments, the wireless circuitry 104A/B and/or a portion thereof can include or be referred to as one or more wireless transmitter(s)/receiver(s) or transceiver(s) or radio(s). The terms circuit, circuitry, component, and component block may be used interchangeably herein, in some embodiments, to refer to one or more operational units of a wireless communication device that process and/or operate on digital signals, analog signals, or digital data units used for wireless communication. For example, representative circuits can perform various functions that convert digital data units to transmitted radio frequency analog waveforms and/or convert received analog waveforms into digital data units including intermediate analog forms and intermediate digital forms. The wireless circuitry 104A/B can include components of RF analog front-end circuitry, e.g. a set of one or more antennas, which can be interconnected with additional supporting RF circuitry that can include filters and other analog components that can be “configured” for transmission and/or reception of analog signals via one or more corresponding antennas to one or more wireless access networks and/or wireless access equipment included therein.

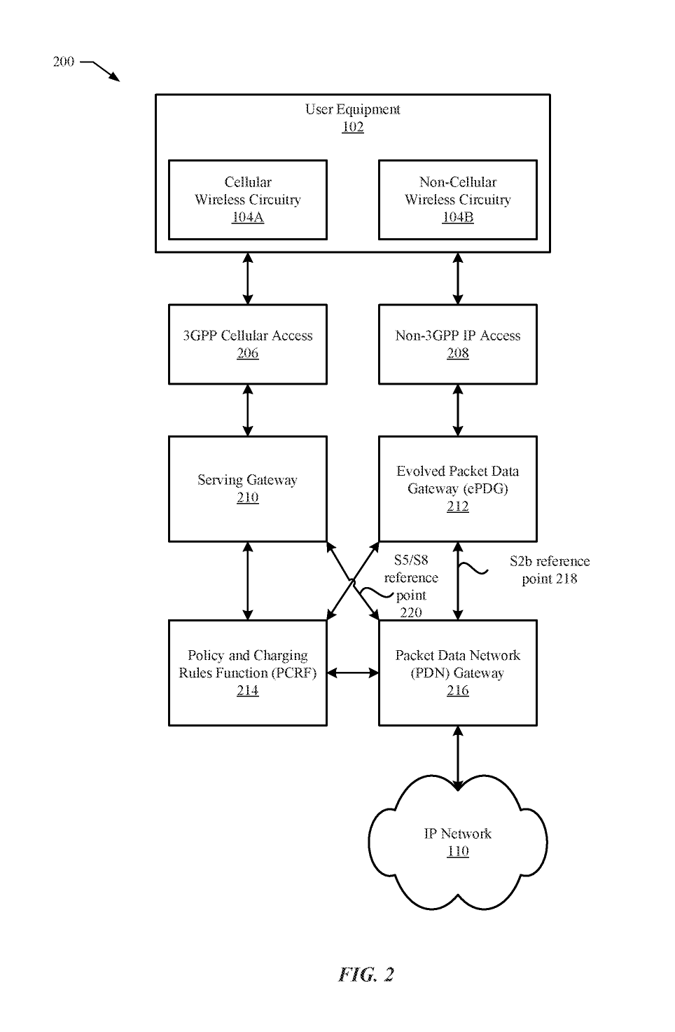

FIG. 2 illustrates an example wireless system 200 that includes the UE 102 communicatively coupled to the IP network 110 through a 3GPP cellular access 206 and/or through a non-3GPP IP-based wireless access 208. In some embodiments, the 3GPP cellular wireless access 206 includes an evolved universal terrestrial access network (E-UTRAN) or other network elements of an LTE/LTE-A wireless network. In some embodiments, the non-3GPP IP access 208 includes a wireless local area network (WLAN) or portions thereof, e.g., a wireless access point, and thus the non-3GPP IP access 208 can also be referred to as a WLAN access. In some embodiments, the WLAN access can also be referred to as a Wi-Fi access to correspond to a WLAN that operates in accordance with an IEEE 802.11 wireless communication protocol. The UE 102 can be configured to connect individually and/or simultaneously to a given packet data network (PDN) through the 3GPP cellular wireless access 206 and the non-3GPP IP-based wireless access 208. The 3GPP cellular access 206 connects to a serving gateway (GW), which connects to a PDN gateway 216 through an S5 reference point 220 or an S8 reference point 220 for roaming users. The PDN gateway 216 provides a connection to the IP network 110 through which a variety of services can be accessed. The non-3GPP IP access 208 connects to an evolved packet data gateway (ePDG) 212, which connects to the PDN gateway 216 through an S2b reference point 218. Each of the serving gateway 210, the ePDG 212, and the PDN gateway 216 are also connected to a policy and charging rules function (PCRF) 214.

The 3GPP S2b reference point 218 between the ePDG 212 and the PDN gateway 216 provides a mechanism to allow the UE 102, when attached via an untrusted non-3GPP IP access network (e.g., non-3GPP IP access 208), to connect securely via a 3GPP evolved packet system (EPS) network to the IP network 110 and to access services via the secure connection. The UE 102 can establish a secure connection, e.g., an Encapsulating Security Payload (ESP) tunnel based on an IP Security (IPsec) protocol, using an IKEv2 protocol signaling exchange between the UE 102 and the ePDG 212, which in turn can establish a secure tunnel, e.g., a Proxy Mobile IPv6 (PMIP) or GTP tunnel, to the PDN gateway 216 when a session for the UE 102 is anchored.

### Support for Emergency Services Access

In some embodiments, for the non-3GPP IP access 208, e.g., such as a WLAN access, when establishing a new connection via the S2b reference point 218, the UE 102 can indicate that the new connection should be dedicated for emergency services, e.g., by providing an indication in a message sent to the ePDG 212 when establishing the new connection. The UE 102 and the ePDG 212 can be considered as IKEv2 peers that exchange information during the establishment of a secure tunnel, e.g., during an authorization and authentication procedure, as part of an “IDr” payload exchange using one or more IKEv2 attributes. In some embodiments, the IKEv2 attributes used can be formatted in accordance with attribute formats as defined in the IETF RFC 5996 and/or IETF RFC 7296, e.g., as shown in one or more of Sections 1.4, 1.5, and 3.15. IKEv2 attributes that can be used for communication between the UE 102 and the ePDG 212 as described herein, and may be defined in one or more 3GPP specifications and/or registered for use with the Internet Assigned Numbers Authority (IANA).

In response to the UE 102 detecting a request for an emergency services connection via an untrusted WLAN over the S2b reference point 218, e.g., based on an input received via a user interface of the UE 102, the UE 102 can deregister from an IMS server for any existing non-emergency services for which the UE 102 can be registered with the IMS server. The UE 102 can also release any existing PDN connections with an existing ePDG 212 used for non-emergency services before establishing a new PDN connection dedicated for emergency services with the same ePDG 212 or with another ePDG 212. The UE 102 can then establish the new PDN connection dedicated for emergency services with an ePDG 212 that supports emergency services via the untrusted WLAN. The UE 102 can register with an IMS server for emergency services for the new PDN connection. The ePDG 212 used for emergency services can be associated with a serving PLMN. The UE 102 can indicate that the new PDN connection is to be dedicated to emergency services by providing an indication as part of a connectivity request for emergency services sent to the ePDG 212. In some embodiments, the indication can be included as part of an IKEv2 message sent by the UE 102 to the ePDG 212. In some embodiments, the ePDG 212 can respond by including an indication of support for emergency services (and/or as an indication of support for the request for emergency services from the UE 102) in an IKEv2 message sent by the ePDG 212 to the UE 102.

### IKEv2 Messages

IKEv2 messages can be exchanged between IKEv2 peers (e.g., the UE 102 and the ePDG 212) as part of one or more exchanges performed during and/or after establishment of a secure tunnel. The messages can be formatted in accordance with formats as defined in various sections of RFC 5996 and/or IETF RFC 7296. In some embodiments, during establishment of the secure tunnel, the UE 102 can provide an indication that a PDN connection being established with the ePDG 212 should be dedicated for emergency services, e.g., as part of an “IDr” payload containing the string “EMERGENCY” in the Identification Data.

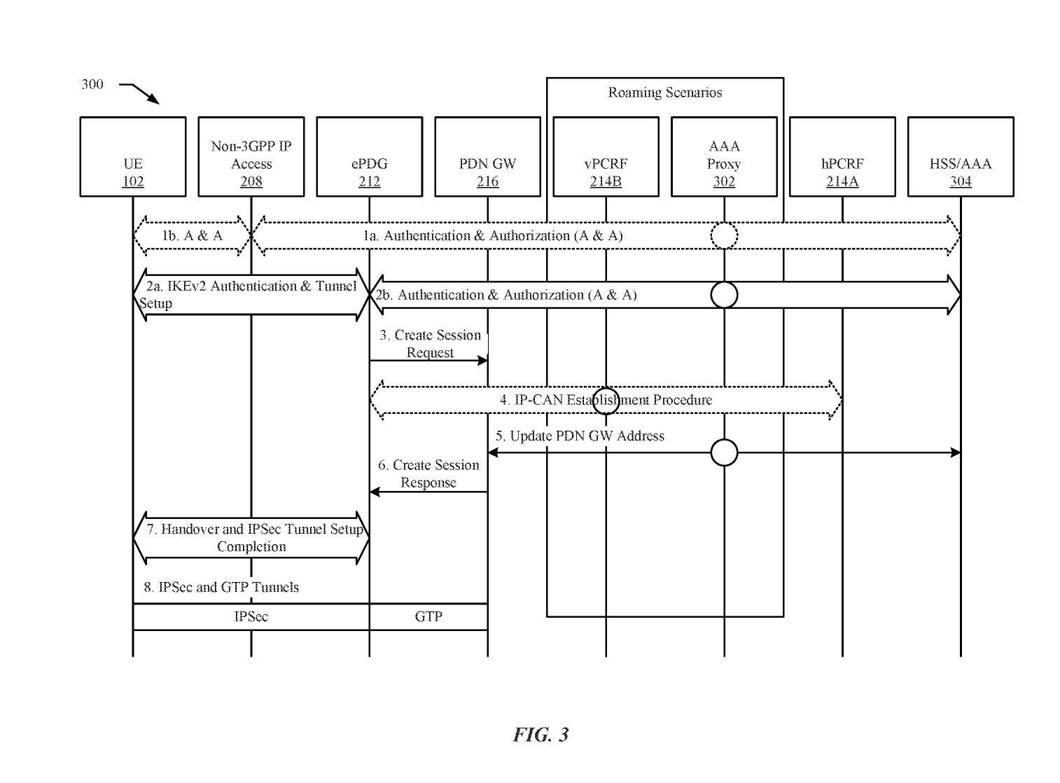

FIG. 3 illustrates a message exchange sequence 300 to establish a non-3GPP IP access 208 (e.g., WLAN access), or to handover an established PDN connection from a 3GPP access 206 to the non-3GPP IP access 208. The UE 102 can perform a non-3GPP IP access attachment, e.g., a WLAN attachment, and can request to establish a PDN connection using an access point name (APN). In step 1a, the UE 102 can discover the non-3GPP IP access 208 and can perform an authentication and authorization (A & A) procedure with the 3GPP EPC via the non-3GPP IP access 208, e.g., as specified in 3GPP TS 23.402, clause 7.2.1. In some embodiments, the UE 102 can also perform an A&A procedure with the non-3GPP IP access 208, as indicated by step 1b (which can occur before step 1a). In steps 2a and 2b, the UE 102 can perform an IKEv2 authentication and tunnel setup procedure via the non-3GPP IP access 208 with the ePDG 212 and with the 3GPP AAA server and home subscription server (HSS/AAA) 404, e.g., as specified in 3GPP TS 33.402. For IP address preservation, the UE 102 can include its own IP address (e.g., an IPv4 address or an IPv6 prefix/address or both), which may have been allocated during a preceding attachment procedure to connect the UE 102 to the 3GPP cellular access 206, in a CFG_REQUEST message sent to the ePDG 212 during an IKEv2 message exchange. In step 3, the ePDG 212 can send a “Create Session Request” message to the PDN gateway 216. In step 4, the PDN gateway 216 initiates an IP-CAN Session Establishment procedure with the “home” PCRF (hPCRF) 214A, or with a “visited” PCRF (vPCRF 214B) for some roaming scenarios. In some embodiments, the UE 102 can be connected via 3GPP cellular access 206 for a “home” wireless network, in which case the “home” PCRF (hPCRF) 214A can participate in the procedures described. In some embodiments, the UE 102 can be connected via 3GPP cellular access 206 for a “visited” wireless network in a roaming scenario, in which case both the “visited” PCRF (vPCRF) 214B and the “home” PCRF (hPCRF) 214A can participate in the procedures described, and communication is via an AAA proxy 402. In step 5, the HSS/AAA 304 is provided an identity of the PDN gateway 216. In step 6, the PDN gateway 216 can send a “Create Session Response” message to the ePDG 212. In step 7, the ePDG 212 can indicate to the UE 102 that the authentication and authorization procedure with the external AAA server (e.g., HSS/AAA 404) is successful. In step 8, IP connectivity between the UE 102 and the PDN gateway 212 can be completed.

Some solutions for emergency services via an untrusted WLAN can be restricted to a UE 102 that has valid credentials to access the EPC via the WLAN and is authorized to connect to the EPC via the WLAN in a location where the UE 102 initiates the emergency services session. In some embodiments, however, any UE 102 capable of communication via an untrusted WLAN can be configured to indicate a request to establish an emergency services connection via the untrusted WLAN, and the UE 102 can be provided an emergency services connection via the untrusted WLAN without requiring authentication and/or specific credentials from the UE 102. Similarly, when handing over an emergency services session from a 3GPP access to access via an untrusted WLAN, the UE 102 can be provided an emergency services connection via the untrusted WLAN, to which the already established emergency services session is being handed over, without requiring authentication and/or specific credentials from the UE 102. In such embodiments, the use of specific IKEv2 messages, without requiring any authentication messages, can be preferred. In some embodiments, the UE 102 can be located in a geographic area in which “regular” authenticated service can be unavailable or for which the UE 102 can be restricted to not be provided with “regular” service but can be configured and allowed to establish an “emergency” services connection, via a cellular wireless access or via an untrusted WLAN. In some embodiments, a UE 102 that is not authenticated can be provided an “emergency” services connection via an untrusted WLAN when handing over from a cellular wireless access. In some embodiments, the UE 102 can include no Universal Subscriber Identity Module (USIM) and/or no Universal Integrated Circuit Card (UICC) and can be still capable of requesting, establishing, and/or transferring an emergency services connection via an untrusted WLAN.

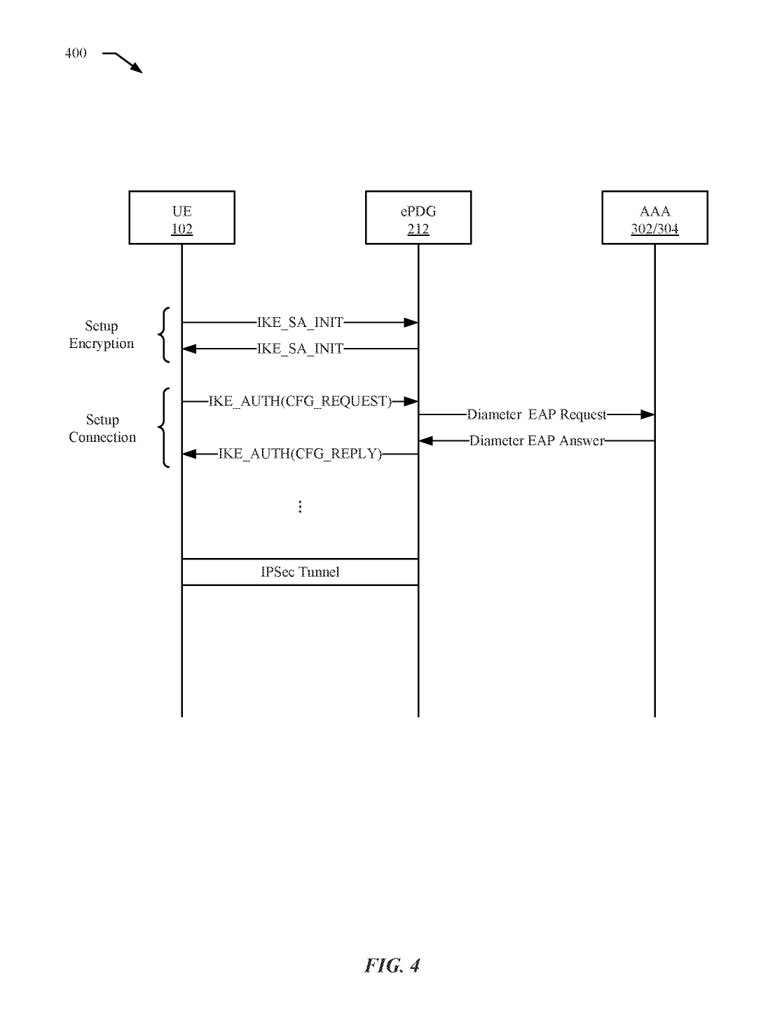

FIG. 4 illustrates a flow chart 400 of a portion of an exemplary signaling message exchange between the UE 102 and the ePDG 212 to establish a secure connection, e.g., an IPSec tunnel (which can occur as part of a handover of an established emergency services session from a 3GPP cellular wireless access to an untrusted non-cellular wireless access.) The signaling exchange shown in FIG. 4 can be part of one or more steps 1b, 2a, 7 and 8 of FIG. 3, as well as message exchanges between the ePDG 212 and one or more network elements, such as AAA server 304 (for a home network) and/or AAA proxy server 302 (for roaming scenarios in a visited network), which can be part of one or more steps 1a and 2b of FIG. 3. To establish an IPSec tunnel, for secure communication between the UE 102 and the ePDG 212, an initial exchange of IKE_SA_INIT request/response messages can be used to setup encryption followed by a second exchange of encrypted messages to setup authentication between the UE 102 and the ePDG 212. The authentication steps can be bypassed or performed only partially, in some embodiments, when establishing the IPSec tunnel to support an emergency services session.

Upon receipt of the IKE_SA_INIT response message from the ePDG 212, the UE 102 can send to the ePDG 212 an IKE_AUTH signaling message with an indication to request to establish an emergency services connection. In some embodiments, the IKE_AUTH request message sent to the ePDG 212 by the UE 102 includes an “IDr” payload that contains a predefined string to indicate an emergency services session, e.g., a string “EMERGENCY”. In some embodiments, when handing over an established emergency services session from a cellular wireless access network to a non-cellular wireless access network, the UE 102 includes previously allocated home address information during establishment of the IPSec tunnel. The UE 102 can send an IPv4 address, which can be referred to as an INTERNAL_IP4_ADDRESS attribute, or an IPv6 address, which can be referred to as an INTERNAL_IP6_ADDRESS attribute, or both as part of the CFG_REQUEST configuration payload with the IKE_AUTH request message to indicate home address information and for a handover attachment. In some embodiments, using both the “IDr” payload that contains the string “EMERGENCY” in the Identification Data together with the previously allocated home address information in the INTERNAL_IP4_ADDRESS attribute or the INTERNAL_IP6_ADDRESS attribute (or both) in the CFG_REQUEST Configuration Payload of the IKE_AUTH request message can indicate that the UE 102 requests a handover of an established emergency services session, e.g., from the cellular wireless access network to the non-cellular wireless access network.

The ePDG 212 can respond to the IKE_AUTH signaling message from the UE 102 by sending to the UE 102 an IKE_AUTH signaling message that does not include the APN in the “IDr” payload that indicates acceptance of the request to establish the emergency services connection for the handover from the cellular wireless access network. In some embodiments, the UE 102 uses a static configuration, e.g., a stored table of values, to determine the ePDG 212 to which to send the IKE_AUTH(CFG_REQUEST) signaling message. In some embodiments, the UE 102 uses a dynamic configuration, e.g., by querying a DNS server with a Fully Qualified Domain Name (FQDN), to determine the ePDG 212 to which to send the IKE_AUTH(CFG_REQUEST) signaling message. In some embodiments, the UE 102 sends the IKE_AUTH(CFG_REQUEST) signaling message to the ePDG 212 without knowledge of whether the ePDG 212 can support the request for an emergency services connection, and when the ePDG 212 supports emergency services, the ePDG 212 responds with the IKE_AUTH(CFG_REPLY) signaling message that includes an indication of support for emergency services.

In some embodiments, the UE 102 is unable to authenticate with the cellular wireless access network and/or with the non-cellular wireless access network but is still configured to provide for establishing emergency services sessions and for transferring via handover an established emergency services session, such as from a cellular wireless access network to a non-cellular wireless access network, without completion of an authentication. In some embodiments, the UE 102 does not include a USIM (or a UICC, or an eSIM of an eUICC) such that the subscriber identity for the UE 102 is unknown. An identity of the UE 102 provided in an IKE_AUTH message sent to the ePDG 212, in some embodiments, includes the IMEI of the UE 102 as a username for an NAI, where “username@realm” is a representative syntax for the NAI as specified in clause 2.1 of the IETF RFC 4282 and the 3GPP TS 33.402. The “realm” part of the NAI can be specified by a particular domain name that is predefined and reserved for use for unauthenticated emergency services access. The AAA server 302/304 can recognize, based on use of the reserved, particular domain name that no authentication (or incomplete authentication) is performed.

In some embodiments, the UE 102 is aware that authentication may fail with the originating and/or the receiving wireless access network, e.g., when no local VPLMN has a roaming agreement with the HPLMN of the UE 102, even though the UE 102 includes a valid USIM (or UICC, or eSIM of an eUICC). The UE 102 includes the IMSI of the UE 102 as the username of the NAI in the IKE_AUTH message sent to the ePDG 212 with the “realm” portion of the NAI specified as the particular, predefined domain name reserved for unauthenticated emergency services access. As above, the AAA server 302/304 can recognize, based on use of the reserved, particular domain name that no authentication (or incomplete authentication) is performed.

In some embodiments, the AAA server 302/304 indicates to the ePDG 102 that the request for handover of the emergency services session is accepted without requiring completion of authentication. Thus, no subscription data for the UE 102 is provided to the ePDG 102. Each of the UE 102 and the AAA server 302/304 generate encryption keys, e.g., a Master Session Key (MSK), locally based on the IMEI or the IMSI (and based on other inputs), and the AAA server 302/304 provides the generated encryption keys to the ePDG 102 for encryption of communication between the UE 102 and the ePDG 212 via the IPSec tunnel.

To handover an established PDN connection used for emergency bearer services, i.e., an emergency services session, from a non-cellular wireless access network, such as from an untrusted WLAN wireless network, to a cellular wireless access network, the UE 102 includes a Request Type information element (IE) in an ATTACH REQUEST message or in a PDN CONNECTIVITY REQUEST message. The Request Type IE can be used to indicate whether the UE 102 requests to establish a new connection to a PDN or to keep a set of one or more connections to which the UE 102 has connected via the non-cellular wireless access network. When requesting handover of an established session, the UE 102 can use a value of “Handover” in the Request Type IE, when connectivity to a PDN is established upon handover from the non-cellular wireless access network, and the UE 102 was connected to the PDN before the handover to the cellular wireless access network. Similarly, the UE 102 can include a value of “Emergency” in the Request Type IE to indicate that the UE 102 requests a session to a PDN that supports emergency bearer services. For handover of an established emergency services session from a non-cellular wireless access network, e.g., an untrusted WLAN wireless network, to a cellular wireless access network, in some embodiments, the UE 102 includes a value of “Emergency Handover” in the Request Type IE of the ATTACH REQUEST message or the PDN CONNECTIVITY REQUEST message.

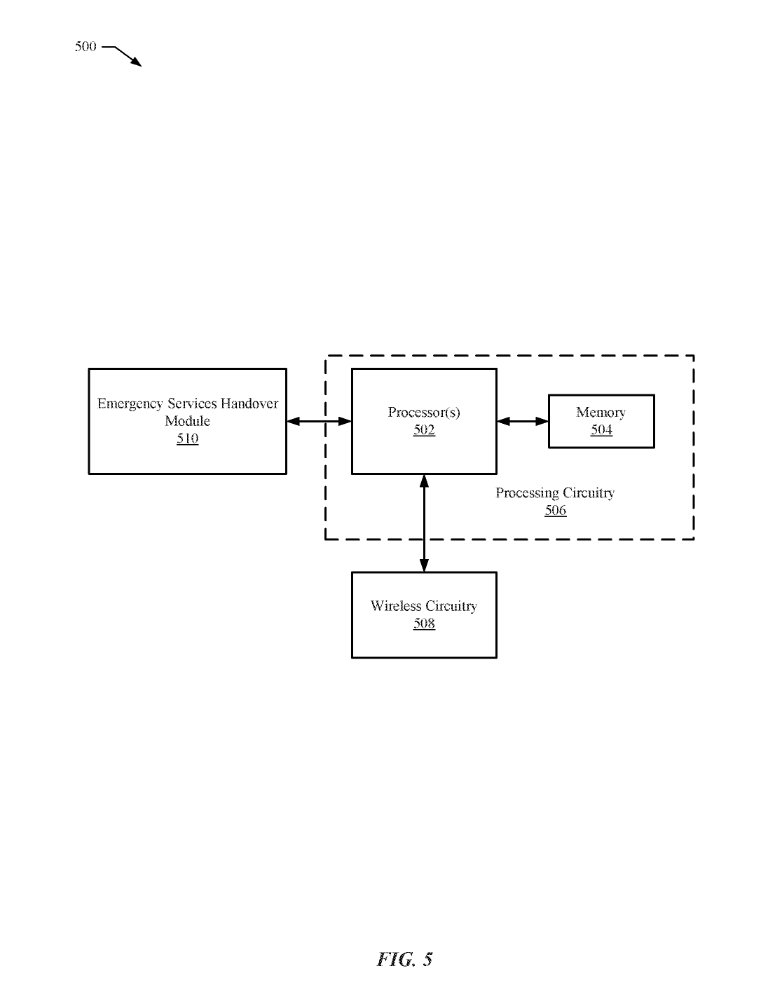

FIG. 5 illustrates, in accordance with some embodiments, a diagram 500 of components of a wireless communication device, such as UE 102, including one or more processor(s) 502 coupled to memory 504, which together can be referred to as processing circuitry 506, wireless circuitry 508 that provides for wireless radio frequency (RF) connections between the UE 102 and various wireless networks, e.g., the 3GPP cellular access 206 using the cellular wireless circuitry 104A and/or the non-3GPP IP access 208 using the non-cellular wireless circuitry 104B. The UE 102 can also include an emergency services handover module 510 configurable to operate together with the processing circuitry 506 and the wireless circuitry 508 to perform one or more operations for the UE 102 as described herein to manage handover of an established emergency services session between wireless networks. In some embodiments, the wireless circuitry 508 includes one or more baseband processor(s), and a set of RF analog front-end circuitry. In some embodiments, the wireless circuitry 508 and/or a portion thereof can include or be referred to as a wireless transmitter/receiver or a transceiver or a radio. The terms circuit, circuitry, component, and component block may be used interchangeably herein, in some embodiments, to refer to one or more operational units of a wireless communication device that process and/or operate on digital signals, analog signals, or digital data units used for wireless communication. For example, representative circuits can perform various functions that convert digital data units to transmitted radio frequency analog waveforms and/or convert received analog waveforms into digital data units including intermediate analog forms and intermediate digital forms. The wireless circuitry 508 can include components of RF analog front-end circuitry, e.g. a set of one or more antennas, which can be interconnected with additional supporting RF circuitry that can include filters and other analog components that can be “configured” for transmission and/or reception of analog signals via one or more corresponding antennas to one or more wireless networks.

The processor(s) 502 and the wireless circuitry 508 can be configured to perform and/or control performance of one or more functionalities of the UE 102, in accordance with various implementations. The processor(s) 502 and the wireless circuitry 508 can provide functionality for establishing connections (sessions), including emergency services sessions, and/or for transferring (handing over) established connections, such as emergency services sessions, of the UE 102 between different wireless networks as described herein. The processor(s) 502 may include multiple processors of different types that can provide for both wireless communication management and/or higher layer functions, e.g., one or more of the processor(s) 502 may be configured to perform data processing, application execution, and/or other device functions according to one or more embodiments of the disclosure. The UE 102, or portions or components thereof, such as processor(s) 502, can include one or more chipsets, which can respectively include any number of coupled microchips thereon.

In some embodiments, the processor(s) 502 may be configured in a variety of different forms. For example, the processor(s) 502 may be associated with any number of microprocessors, co-processors, controllers, or various other computing or processing implements, including integrated circuits such as, for example, an application specific integrated circuit (ASIC), a field programmable gate array (FPGA), or any combination thereof. In various scenarios, multiple processors 502 of the UE 102 can be coupled to and/or configured in operative communication with each other, and these components may be collectively configured to perform emergency services session handovers between wireless networks. In some implementations, the processor(s) 502 can be configured to execute instructions that may be stored in memory 504, or that can otherwise be accessible to the processor(s) 502 in some other device memory. As such, whether configured as, or in conjunction with, hardware or a combination of hardware and software, the processor(s) 502 may be capable of performing operations according to various implementations described herein, when configured accordingly. In various embodiments, memory 504 in the UE 102 may include multiple memory devices that can be associated with any common volatile or non-volatile memory type. In some scenarios, the memory 504 may be associated with a non-transitory computer-readable storage medium that can store various computer program instructions, which may be executed by the processor(s) 502 during normal program executions. In this regard, the memory 504 can be configured to store information, data, applications, instructions, or the like, for enabling the UE 102 to carry out various functions in accordance with one or more embodiments of the disclosure. In some implementations, the memory 504 may be in communication with, and/or otherwise coupled to, the processor(s) 502, as well as one or more system buses for passing information between and amongst the different device components of the UE 102.

It should be appreciated that not all of the components, device elements, and hardware illustrated in and described with respect to the UE 102 shown in FIG. 5 may be essential to this disclosure, and thus, some of these items may be omitted, consolidated, or otherwise modified within reason. Additionally, in some implementations, the subject matter associated with the UE 102 can be configured to include additional or substitute components, device elements, or hardware, beyond those depicted within the illustration of FIG. 5.

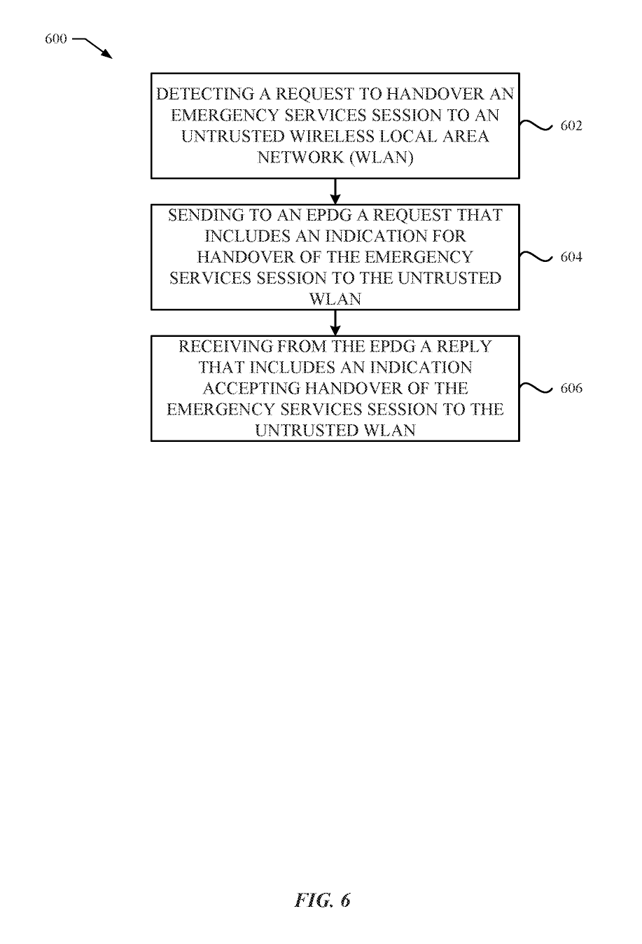

FIG. 6 illustrates a flowchart 600 of an example method to handover an emergency services session for a wireless device between a cellular wireless access network and a non-cellular wireless access network, e.g., a WLAN wireless network. The method illustrated by flowchart 600 is implemented at the wireless device, at least in part, in some embodiments. In step 602, the wireless communication device (such as UE 102) detects a request to handover an emergency services session, already established via a cellular wireless access network, to an non-cellular wireless access network, e.g., to an untrusted WLAN wireless network. In step 604, the UE 102 sends to an ePDG 212 a request that includes an indication of a handover of the emergency services session to the non-cellular wireless access network. In step 606, the UE 102 receives from the ePDG 212 a reply that includes an indication of an acceptance of the handover of the emergency services session to the non-cellular wireless access network, e.g., the untrusted WLAN wireless network. In some embodiments, the request is an IKE_AUTH request message sent by the UE 102 to the ePDG 212. In some embodiments, the request includes a payload containing a set of values that indicates an emergency services handover. In some embodiments, the set of values includes a predefined value associated with emergency services, e.g., a string “EMERGENCY” in an Identification Data payload. In some embodiments, the set of values includes a previously allocated IPv4 address and/or IPv6 address. In some embodiments, the ePDG 212 recognizes the emergency services handover based on the inclusion of both the “EMERGENCY” string (or equivalent) predefined value and the previously allocation IP address(es). In some embodiments, the UE 102 includes an NAI in the IKE_AUTH request message sent to the ePDG 212, with the NAI including either an IMEI of the UE 102 or an IMSI of the UE 102. In some embodiments, the UE 102 includes the IMEI when the UE 102 does not include a physical SIM or an electronic SIM. In some embodiments, the UE 102 includes the IMSI when the UE 102 includes a physical symbol or an electronic SIM, but authentication via the cellular wireless network and/or via the non-cellular wireless access network will fail.

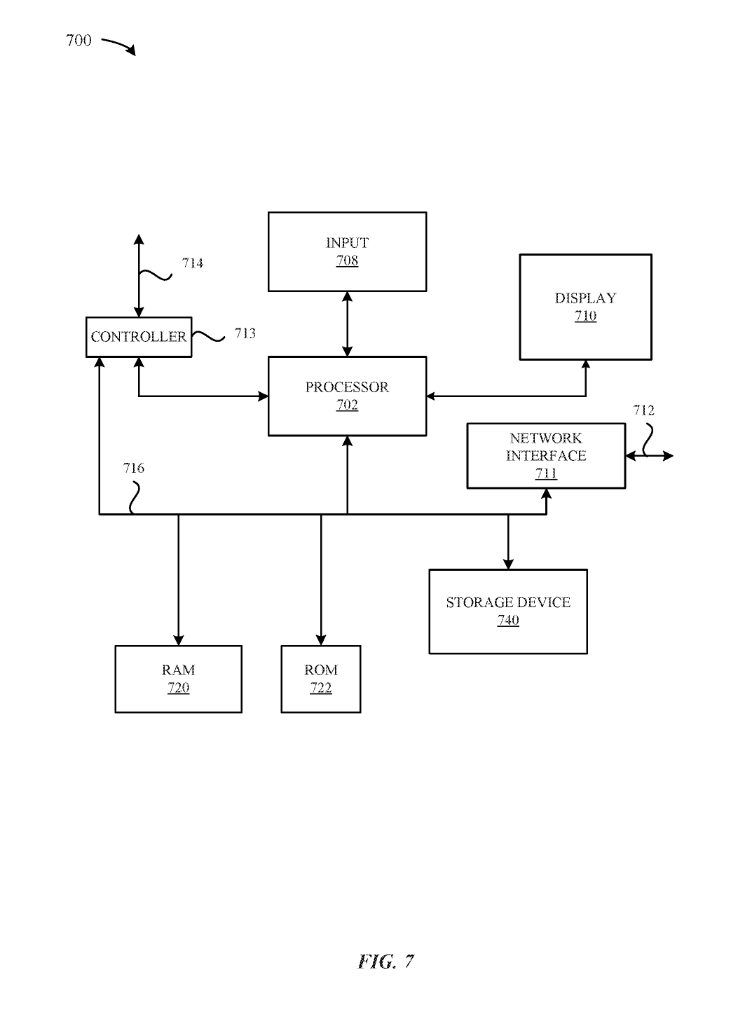

FIG. 7 illustrates a block diagram 700 of an example representative set of elements of a wireless communication device that can be used to implement the various components and techniques described herein. In particular, the detailed view of the exemplary wireless communication device illustrates various components that can be included in the wireless device 102 illustrated in FIG. 1. As shown in FIG. 7, the computing device 700 can include a processor 702 that represents a microprocessor or controller for controlling the overall operation of computing device 700. The computing device 700 can also include a user input device 708 that allows a user of the computing device 700 to interact with the computing device 700. For example, the user input device 708 can take a variety of forms, such as a button, keypad, dial, touch screen, audio input interface, visual/image capture input interface, input in the form of sensor data, etc. Still further, the computing device 700 can include a display 710 (screen display) that can be controlled by the processor 702 to display information to the user (for example, visual/silent alert notifications and/or information relating to incoming, outgoing, or active communication sessions). A data bus 716 can facilitate data transfer between at least a storage device 740, the processor 702, and a controller 713. The controller 713 can be used to interface with and control different equipment through an equipment control bus 714. The computing device 700 can also include a network/bus interface 711 that couples to a data link 712. In the case of a wireless connection, the network/bus interface 711 can include wireless circuitry, such as a wireless transceiver and/or baseband processor.

The computing device 700 also includes a storage device 740, which can comprise a single storage or a plurality of storages (e.g., hard drives), and includes a storage management module that manages one or more partitions within the storage device 740. In some embodiments, storage device 740 can include flash memory, semiconductor (solid state) memory or the like. The computing device 700 can also include a Random Access Memory (“RAM”) 720 and a Read-Only Memory (“ROM”) 722. The ROM 722 can store programs, utilities or processes to be executed in a non-volatile manner. The RAM 720 can provide volatile data storage, and stores instructions related to the operation of the computing device 700.

The various aspects, embodiments, implementations or features of the described embodiments can be used separately or in any combination. Further, some aspects of the described embodiments may be implemented by software, hardware, or by a combination of hardware and software. The described embodiments can also be embodied as computer program code stored on a non-transitory computer-readable medium. The computer readable-medium may be associated with any data storage device that can store data, which can thereafter be read by a computer or a computer system. Examples of the computer-readable medium include read-only memory, random-access memory, CD-ROMs, Solid-State Disks (SSD or Flash), HDDs, DVDs, magnetic tape, and optical data storage devices. The computer-readable medium can also be distributed over network-coupled computer systems so that the computer program code may be executed in a distributed fashion.

The foregoing description, for purposes of explanation, used specific nomenclature to provide a thorough understanding of the described embodiments. However, it will be apparent to one skilled in the art that some of the specific details are not required in order to practice the described embodiments. Thus, the foregoing descriptions of specific embodiments are presented herein for purposes of illustration and description. These descriptions are not intended to be exhaustive, all-inclusive, or to limit the described embodiments to the precise forms or details disclosed. It will be apparent to one of ordinary skill in the art that many modifications and variations are possible in view of the above teachings, without departing from the spirit and the scope of the disclosure.

What is claimed is:

1. A method to handover an established emergency services session between a 3GPP cellular wireless access network and a non-3GPP wireless access network, the method comprising:
by a wireless device:
detecting a request to handover the established emergency services session to the non-3GPP wireless access network;
sending to an evolved packet data gateway (ePDG) a request that includes an indication of a handover of the emergency services session to the non-3GPP wireless access network; and
receiving from the ePDG a reply that includes an indication accepting handover of the emergency services session to the non-3GPP wireless access network.

2. The method of claim 1, wherein the request includes a predefined value that indicates emergency services and a network access identifier (NAI) that includes a domain name reserved for unauthenticated emergency services.

3. The method of claim 2, wherein the request further includes an International Mobile Equipment Identity (IMEI) as a username to identify the wireless device, when the wireless device does not include a subscriber identity module (SIM).

4. The method of claim 2, wherein the request further includes an International Mobile Subscriber Identity (IMSI) as a username to identify the wireless device, when the wireless device includes a subscriber identity module (SIM) that is not usable for authentication via the 3GPP cellular wireless access network or for authentication via the non-3GPP wireless access network.

5. The method of claim 2, wherein the request indicates emergency services by including a predefined string in an IDr payload of an IKE_AUTH request message sent to the ePDG.

6. The method of claim 1, further comprising:
establishing an Internet Protocol Security (IPSec) tunnel between the wireless device and the ePDG without completion of an authentication procedure.

7. The method of claim 6, further comprising:
generating a Master Session Key (MSK) based on a username provided to the ePDG to identify the wireless device in the request.

8. The method of claim 6, further comprising:
completing an encryption establishment procedure with the ePDG before establishing the IPSec tunnel.

9. The method of claim 6, wherein the wireless device provides to the ePDG during establishment of the IPSec tunnel previously allocated home address information that includes an IPv4 or IPv6 address attribute.

10. An apparatus configurable for operation in a wireless device, the apparatus comprising:
one or more processors communicatively coupled to a storage medium storing
instructions that, when executed by the one or more processors, cause the wireless device to perform a method comprising:
detecting a request to handover an established emergency services session from a 3GPP cellular wireless access network to a non-3GPP wireless access network;
sending to an evolved packet data gateway (ePDG) a request that includes an indication of a handover of the emergency services session to the non-3GPP wireless access network; and
receiving from the ePDG a reply that includes an indication accepting handover of the emergency services session to the non-3GPP wireless access network.

11. The apparatus of claim 10, wherein the request includes a predefined value that indicates emergency services and a network access identifier (NAI) that includes a domain name reserved for unauthenticated emergency services.

12. The apparatus of claim 11, wherein the request further includes an International Mobile Equipment Identity (IMEI) as a username to identify the wireless device, when the wireless device does not include a subscriber identity module (SIM).

13. The apparatus of claim 11, wherein the request further includes an International Mobile Subscriber Identity (IMSI) as a username to identify the wireless device, when the wireless device includes a subscriber identity module (SIM) that is not usable for authentication via the 3GPP cellular wireless access network or for authentication via the non-3GPP wireless access network.

14. The apparatus of claim 11, wherein the request indicates emergency services by including a predefined string in an IDr payload of an IKE_AUTH request message sent to the ePDG.

15. The apparatus of claim 10, wherein the method performed by the wireless device further comprises:
establishing an Internet Protocol Security (IPSec) tunnel between the wireless device and the ePDG without completion of an authentication procedure.

16. The apparatus of claim 15, wherein the method performed by the wireless device further comprises:
generating a Master Session Key (MSK) based on a username provided to the ePDG to identify the wireless device in the request.

17. The apparatus of claim 15, wherein the method performed by the wireless device further comprises:
completing an encryption establishment procedure with the ePDG before establishing the IPSec tunnel.

18. The apparatus of claim 15, wherein the wireless device provides to the ePDG during establishment of the IPSec tunnel previously allocated home address information that includes an IPv4 or IPv6 address attribute.

19. A wireless device comprising:
wireless circuitry comprising one or more antennas; and
one or more processors communicatively coupled to a storage medium storing
instructions that, when executed by the one or more processors, cause the wireless device to perform a method comprising:
detecting a request to handover an established emergency services session from a 3GPP cellular wireless access network to a non-3GPP wireless access network;
sending to an evolved packet data gateway (ePDG) a request that includes an indication of a handover of the emergency services session to the non-3GPP wireless access network; and
receiving from the ePDG a reply that includes an indication accepting handover of the emergency services session to the non-3GPP wireless access network.

20. The wireless device of claim 19, wherein the request includes a predefined value that indicates emergency services and a network access identifier (NAI) that includes a domain name reserved for unauthenticated emergency services.
